(19) United States
(12) Patent Application Publication
(10) Pub. No.: US 2023/0400344 A1
(43) Pub. Date: Dec. 14, 2023

(54) WEIGHING DEVICE AND WEIGHING METHOD, WITH CENTRAL DIGITAL MEASURED VALUE CORRECTION

(71) Applicant: Schenck Process Europe GmbH, Darmstadt (DE)

(72) Inventor: Samuel BOUVRON, Darmstadt (DE)

(73) Assignee: Schenck Process Europe GmbH, Darmstadt (DE)

(21) Appl. No.: 18/237,713

(22) Filed: Aug. 24, 2023

Related U.S. Application Data
(63) Continuation of application No. PCT/EP2022/054467, filed on Feb. 23, 2022.

(30) Foreign Application Priority Data
Feb. 24, 2021 (DE) 10 2021 104 430.8

(51) Int. Cl. G01G 3/14; G01G 3/18

(52) U.S. Cl. CPC G01G 3/1416; G01G 3/18; G01G 3/1418

(57) ABSTRACT

A weighing device and a weighing method, with central digital measured value correction. The weighing device is simulated on a central analytical unit including a digital function simulator of the weighing device. The digital function simulator of the weighing device is trained by a training device so that errors of measurement of the weighing device can be compensated. In this way, it is possible to obtain reliable and precise weighing results with weighing devices of little complexity.

This nonprovisional application is a continuation of International Application No. PCT/EP2022/054467, which was filed on Feb. 23, 2022, and which claims priority to German Patent Application No. 10 2021 104 430.8, which was filed in Germany on Feb. 24, 2021, and which are both herein incorporated by reference.

### BACKGROUND OF THE INVENTION

### Field of the Invention

The present invention relates to a weighing device and a weighing method, with central digital measured value correction.

### Description of the Background Art

Weighing devices are used to measure forces, especially the weight forces of material to be weighed.

Weighing devices usually have a force absorption, a load cell and an analytical unit.

The force absorption is a physical structure or a body on which the material to be weighed can be applied so that the force absorption absorbs the weight force of the material to be weighed and dissipates it to a substrate. The load cell comprises one or more force sensors and is used to detect the weight force absorbed by the force absorption. Industrial weighing devices can also include multiple load cells. The load cells are arranged in the frictional path from the force absorption to the substrate, i.e., that they detect all or part of the weight force that is dissipated into the substrate via the load cell(s).

The load cells can detect changes in the shape of a measuring body that is associated with the force absorption or is part of the force absorption, for example by means of strain gauges. The strain gauges can be, e.g., attached to a support of the force absorption and detect the deformation of the support, from which the applied weight force can be determined. In this way, shear forces can also be measured on horizontal beams, which are proportional to the weight force. There are therefore many different ways in which the load cells can be arranged in the weighing device.

Usually, each load cell is assigned an analytical unit with which the weight force measured with the load cell is determined. If a weighing device has several load cells, then the corresponding weight forces are added.

EP 0 670 479 A1, which corresponds to U.S. Pat. No. 5,623,128, shows a load cell in which a modular correction device is integrated. This load cell may also have a temperature sensor to take into account the measured temperature when correcting the measuring signals.

JP H11-37827 A discloses a weighing device with an integrated correction function. This weighing device has different characteristic curves for different temperatures and different load directions. This corrects temperature and hysteresis effects.

DE 10 2006 009 005 A1 specifies a method for replacing load cells in a calibrated weighing arrangement with a plurality of load cells. The load cells are connected to a control unit via at least one bus system. The load cells provide weight values to be measured in the form of voltages, which produce corresponding counter values in the control unit. Each load cell has a set of internal parameters per load cell. When the load cells are replaced, the stored data of internal parameters of the new load cell in the weighing arrangement are made available for readout in the respective internal parameter memory of the load cells.

GB 1 495 278 A provides a further method in which the influence of temperature during the weighing process is compensated.

In EP 2 457 070 B1, which corresponds to US 2012/0173168, another weighing device is disclosed, which has a temperature sensor to correct temperature-dependent effects.

In direct weighing technologies, as described for example in “news, Neues von SCHENCK PROCESS, Heavy Industry 12.2005 GB, 20 years SCHENCK—Direct Weighing Technologies, perfectly suited weighing solutions for steel industry”, the force sensors or load cells are rigidly connected to the force absorption, usually screwed or glued.

This results in advantages for direct weighing technologies, such as no moving parts and no mechanical adjustment work. Furthermore, the load cells are low-maintenance and insensitive to contamination.

However, these direct weighing technologies also have disadvantages. Transverse forces are applied to the load cells, which can lead to considerable interference in the measuring signals. The omission of elastomeric bearings or other means of shielding from interference can thus significantly impair the measurement result.

### SUMMARY OF THE INVENTION

It is therefore an object of the present invention to provide a weighing device and a weighing method which make it possible to carry out force measurements with high accuracy, wherein the weighing device used is to be very simple, cost-effective and reliable.

According to an example of the present invention, a weighing device is provided with a central digital measured value correction, comprising at least one load cell which is connected via a signal and/or data line to a central analytical unit for transmitting a weight measuring signal, wherein the central analytical unit has an analytical unit for determining the force measured with the weighing device from the weight measuring signal.

The weighing device is characterized by the fact that the analytical unit comprises a digital function simulator of the weighing device that has one or more error simulation modules, wherein each error simulation module represents a model of the weighing device simulating one specific error of measurement of the weighing device, and each error simulation module has one or more model parameters with which the weighing device is modelled, and a training device is provided, with which the model parameters can be determined during a training process in which reference measuring signals are generated by means of one or more reference loads, wherein the function simulator has a characteristic curve module that converts the weight measuring signal into a weight signal or vice versa and the characteristic curve module has characteristic curve parameters which are determined by means of the training device during the training process.

As explained in more detail below in the example, an error simulation module changes a signal. This change can be made in such a way that a predetermined error is added to the signal. However, this change can also be a change in the signal in that the signal is cleaned or corrected for a predetermined error.

With both types of error simulation modules, it is possible to form a function simulator with which a corrected weight value can be output by the analytical unit, which has been cleared of errors of measurements.

The central digital measured value correction by means of a digital function simulator, which is trained by means of a training process, allows for the use of one or more simple load cells integrated on the weighing device. By training the characteristic curve of the entire weighing device by means of the characteristic curve module and training some or more error simulation modules, calibration of a single load cell for the entire weighing device is negligible, rather the characteristic curve and/or the error simulation modules are trained at once or one after the other for the entire weighing device by means of the function simulator.

The mechanical design of the weighing device with a force absorption and one or more load cells can thus initially be set up according to the local conditions. The load cells are connected to the central analytical unit via a signal and/or data line and then the characteristic curve parameters of the characteristic curve module and the model parameters of the one or more error simulation modules are trained.

The function simulator thus represents the entire weighing device. By using one or more error simulation modules, a very simple structure of the weighing device can be used, which leads to an inherently error-prone weight measuring signal and/or very simple load cells can be used, which are error-prone, and/or the load cells can be rigidly connected to the force absorption (=direct weighing technologies), whereby errors are caused in particular by transverse forces. All these errors can be compensated centrally by means of the digital function simulator. This results in a very precise weighing device, while at the same time keeping the structure of the entire weighing device very simple and cost-effective. This is achieved primarily by combining the central measured value correction by means of the digital function simulator and the training of the function simulator by means of the training device.

Preferably, the characteristic curve module for converting the weight signal into a (virtual) weight measuring signal and the error simulation modules for changing this weight measuring signal are designed around an error component.

The weight signal is an analog or digital signal that represents the weight to be measured. The weight measuring signal is a signal that corresponds to the measuring signal generated by the load cells. When using a single strain gauge, the weight measuring signal corresponds to the strain of the strain gauge.

In such a function simulator, the input value is the weight signal, and the output value is a simulated error-prone weight measuring signal. Such a function simulator can be trained very easily by means of reference loads.

In principle, however, it is also possible for the characteristic curve module to convert an error-prone weight measuring signal into an error-prone weight value and for the error simulation module(s) to convert the error-prone weight signal or the error-prone weight value into a corrected weight value. In this “inverted” function simulator, the input variable is the error-prone, actually measured weight measuring signal and the output variable is the corrected weight value. These error simulation modules can also be referred to as correction modules because they correct the weight value for the respective error. However, the modeling of the inverted function simulator is much more complex than that of the non-inverted function simulator.

Preferably, some of the plurality of error simulation modules can be switched off. In the function simulator, the switched off error simulation modules can be replaced by the factor “1” so that the weight measuring signal or the output weight value output by the characteristic curve module is not changed by a switched off error simulation module. The weighing device may have several load cells, wherein the signals from the individual load cells are combined with the weight measuring signal in a measuring signal collection station. The combination of the individual signals to the weight measuring signal is done by adding, wherein individual signals can also be provided with a different factor, which can differ from “1” if different levers act on the load cells. The factors can also have different signs if tensile and compressive loads act on different load cells at the same time. The combination of the signals from the individual load cells is determined by the structure of the force absorption.

The load cells may have analog outputs, which are connected to the central analytical unit with one or more signal lines for transmitting an analog signal. Load cells with analog outputs are, for example, strain gauges without their own signal processing. The load cells may also have digital outputs, which are connected to the central analytical unit with one or more data lines for transmitting a digital signal. Such load cells with digital outputs have a digital processing of the measuring signals, which are usually recorded in analog form.

The load cell(s) may have one or more strain gauges. In particular, the strain gauges (DMS) can be arranged in a Wheatstone bridge.

The load cells can be integrated into the weighing device with a rigid connection, i.e., they can be rigidly coupled to the force absorption. The force absorption is an arbitrary weighing body or body to be weighed, such as a container, bridge, pan or frame, which is used to hold the weighing material. A rigid connection is created, for example, by means of a material-bonded connection (soldering, welding, gluing) of a positive connection (screw connection, press connection) for force absorption. A rigid connection means that no elastomeric bearings or the like are provided between the load cell and the force absorption, for example, to eliminate transverse forces or other interference forces. Such a rigid connection is maintenance-free but can lead to shear forces and other forces interfering with the measurement being absorbed by the respective load cell. According to the invention, these interfering effects can be corrected centrally by means of the digital function simulator.

Furthermore, the weighing device can be designed in such a way that the flow of force between the force absorption and the substrate is directed exclusively via the load cell(s). With such a design of the weighing device, there are no force shunts that could cause errors of measurement.

The weighing device may have one or more temperature sensors located in the vicinity of at least one of the load cells. With such a temperature sensor, the temperature in the area of the load cells can be recorded and used for correction by means of the digital function simulator.

Preferably, at least two or more error simulation modules are provided to correct one of the error causes:
linearity;
creepage (force absorption, load cell);
hysteresis;
thermal deviations of the zero point;
deviations of the zero point with respect to a thermal gradient;
deviations in the sensitivity of the load cells due to temperature changes;
blows;
position of the load;
transverse forces; and/or
errors due to inclination.

It is possible to train the weighing device by means of a very general function simulator, which is based, for example, on a neural network or another general self-learning model. However, such a general simulation requires a variety of reference loads in all possible states. The states can vary depending on the temperature, the location of the load and the load dynamics. With such a general simulation, the training process is very time-consuming.

The function simulator according to the invention, which comprises a characteristic curve module and at least one and preferably several error simulation modules, thus already has a model structure typical of the weighing device, with which at least the characteristic curve and one or more error causes are mapped. This makes it much easier and faster to train the function simulator than with a general function simulator. In the case of simply designed weighing devices, it has been shown in practice that both the characteristic curve parameters and the model parameters could be reliably determined with only a few reference loads. In the case of weighing devices for weighing large loads (e.g., a few tons), it can be very costly to be able to provide a large number of different reference loads. With the function simulator according to the invention, it has been shown that sometimes a few different reference loads and the zero load are sufficient to reliably train the function simulator.

The analytical unit may have a low-pass filter for filtering a temperature value, in particular a temperature value of a measuring body of a load cell.

By filtering with the low-pass filter, the filtered value corresponds to a delayed temperature value. This delayed temperature value sometimes corresponds better to the actual temperature of a body than the measured temperature, especially if it has a significantly greater heat capacity than the temperature sensor. This filtered temperature value can, e.g., be used as a temperature value for a measuring body of a load cell.

This temperature value filtered with the low-pass filter can also be used to calculate a temperature gradient, wherein the difference between the actual measured temperature value and the filtered temperature value is formed. Such a temperature gradient has an influence, for example, on thermal stresses of a measuring body.

This is a very simple option, which only requires a single temperature sensor to determine a gradient.

An analytical unit and such a method for analyzing the measuring signal of a load cell with such a filtered temperature value represents an independent inventive idea, which can also be used independently of the digital function simulator, in particular to determine a gradient and/or to correct the output of a load cell.

According to a further aspect, a weighing method, with a central digital measured value correction is provided, in which at least one load cell is used to record a weight measuring signal transmitted via a signal and/or data line to a central analytical unit, wherein the central analytical unit determines with an analytical unit the force measured with the weighing device on the basis of the weight measuring signal, and the analytical unit converts the weight measuring signal into a weight signal, using a digital function simulator of the weighing device to simulate the weighing device with its error effects and thus compensate for the errors in the weight signal.

By simulating the weighing device with its error effects, the error effects in the output weight signal can be compensated. This allows for the use of faulty simple load cells or a faulty simple weighing device, with precise weighing of a material to be weighed still being possible.

Preferably, the digital function simulator has been trained in advance with a training device during a training process in which reference measuring signals have been generated by means of one or more reference loads. This allows for a weighing device to be created individually and yet it is easy to weigh material reliably and precisely. This allows for individual local conditions to be taken into account and the use of force absorption in a wide variety of forms. By training the digital function simulator on the weighing device, the errors of the weighing device caused by the design are automatically compensated. The combination of the modular digital function simulator and the training allows for a quick and easy realization of individual weighing devices for a wide variety of applications.

A characteristic curve module of the function simulator can convert the weight measuring signal into the weight signal or vice versa for simulation, wherein the characteristic curve module has characteristic curve parameters that can be determined in advance by means of the training process.

Since this method is used to teach the characteristic curve itself, the characteristic curve of a load cell itself is irrelevant. Rather, the characteristic curve of the entire weighing device is trained, which means that the influence of the other components of the weighing device, such as force absorption, measuring body, etc. are automatically taken into account.

The training is preferably carried out with an optimization method, in particular an iterative optimization method in which the individual parameters are optimized step by step.

One or more error simulation modules of the digital function simulator of the weighing device may each simulate at least one specific error of measurement of the weighing device, and each error simulation module may use one or more model parameters which have been predetermined by means of the training process.

The individual aspects can be applied independently or in combination.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a part of a container scale in the case of a blast furnace equipped with direct weighing technologies,

FIG. 2 shows, schematically, the structure of a weighing device in a block diagram,

FIG. 3 shows a module for analyzing the measuring signals, which has a digital function simulator, in a block diagram,

FIG. 4 shows the digital function simulator from FIG. 3 with a characteristic curve module and several error simulation modules in a block diagram,

FIG. 5 shows a part of a rail scale in a schematic representation, and

FIG. 6 shows a part of a bogie scale with a reference system.

### DETAILED DESCRIPTION

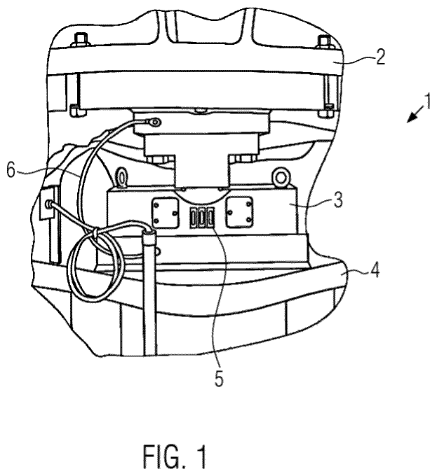

A an example of a weighing device according to the invention is a blast furnace top scale (FIG. 1).

As a force absorption, the weighing device has a container 2 for holding a liquid melt. The weighing device 1 has three load cells 3. Each of the three load cells 3 is arranged between the container 2 and a base plate 4. The container 2 is supported exclusively by the load cells 3, so that no frictional connection can occur parallel to the load cells 3. The base plate 4, which forms the substrate, is also referred to as the connection structure.

The load cells 3 are rigidly connected to the container 2. In the present embodiment, they are screwed to the container 2. Often, in weighing devices, elastomeric bearings are used to couple the respective load cell to the force absorption in order to decouple interference forces and to ensure that the flow of force from the force absorption into the load cell 3 only takes place in the desired direction. Such elastomeric bearings require a lot of maintenance. In addition, such elastomeric bearings are sensitive to heat and it is therefore difficult to use them in a weighing device for melt from a blast furnace. The rigid connection requires much less maintenance than coupling using elastomer bearings. However, the rigid connection between the load cells 3 and the container 2 has the disadvantage that interference forces are also transmitted to the load cells 3, which can impair the measurement.

The individual load cells 3 have strain gauges (DMS) 5 as sensors. For example, the strain gauges can be connected in a Wheatstone bridge.

The individual load cells 3 have a readout device with an A/D converter so that a digital measuring signal is output.

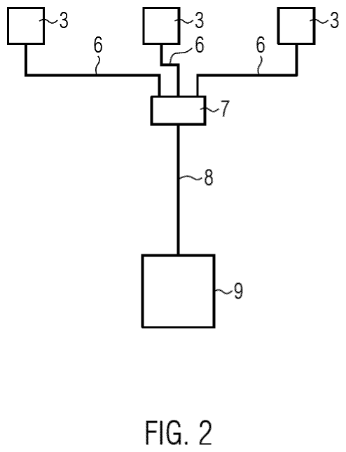

The load cells 3 are each connected to a measuring signal collection station 7 with a data line 6 (FIG. 2). At the measuring signal collection station 7, measuring signals from the individual load cells 3 are read in and combined with each other. In the present embodiment, the measuring signals of the three load cells 3 are added together, since the measurement arrangement is designed in such a way that all three load cells basically measure the same proportion of the load. However, it may be that the leverage ratios with which the load acts on the respective load cell differ, so that the measuring signals of the individual load cells must be multiplied by a factor in order to generate a correct overall signal.

The measuring signal Sₘ(t) generated by the measuring signal collection station 7 is transmitted via another data line 8 to a central analytical unit 9.

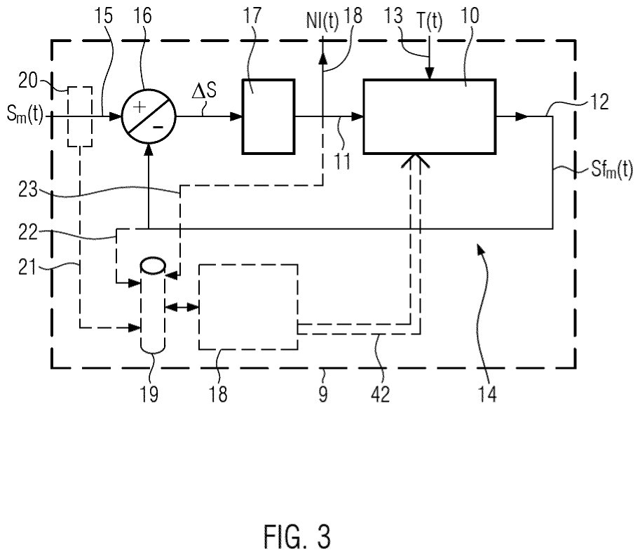

The central analytical unit 9 has a digital function simulator 10 of the weighing device 1 (FIG. 3, 4). A signal describing the weight M(t) measured by the weighing device 1 is applied at an input 11 of the digital function simulator. At an output 12 of the digital function simulator 10, a signal is output that reproduces a simulated measuring signal sfₘ(t), wherein in the present embodiment, the simulated measuring signal is modified in such a way that the errors of the weighing device 1 are simulated so that the simulated measuring signal is an error-prone measuring signal sfₘ(t).

The function simulator 10 represents a digital simulation of the weighing device 1, wherein the simulated measuring signal sfₘ(t) is output when a predetermined weight M(t) is applied.

Optionally, the digital function simulator 10 may have one or more inputs for disturbance variables, which are taken into account in the simulation of the measuring signal. In the present embodiment (FIG. 3), a signal that reflects the temperature T(t) on the load cells 3 is specified as a disturbance variable in the digital function simulator 10.

The digital function simulator 10 is part of an evaluation loop 14, which has an input 15 for receiving the measuring signal sₘ(t) from the measuring signal collector station 7. The input 15 is connected to a comparator 16. The comparator 16 is further connected to the output 12 of the digital function simulator 10 and calculates the difference between the measured measuring signal sₘ(t) and the simulated error-prone measuring signal sfₘ(t) output by the function simulator 10. The comparator 16 outputs a differential signal Δs, which is forwarded to a downstream integrator 17. The integrator 17 integrates the differential signal Δs and outputs the weight signal M(t). The output of the integrator 17 is connected to the input 11 of the digital function simulator 10. Furthermore, an output 18 is provided at the connection between the integrator 17 and the digital function simulator 10, which leads out of the central analytical unit 9 and at which the signal describing the weight M(t) is output.

As explained in more detail below, the digital function simulator 10 is designed in such a way that the error-prone measuring signal sfₘ(t) is generated on the basis of the weight signal M(t) applied to the input. The digital function simulator 10 is thus used to simulate the systematic errors of the weighing device 1.

As long as there is a difference between the measured measuring signal sₘ(t) and the simulated error-prone measuring signal sfₘ(t), the differential signal Δs deviates from zero and by integrating by means of the integrator 17, the value of the weight signal M(t) increases or decreases depending on the sign of the differential signal Δs. If the measured measuring signal sₘ(t) corresponds to the simulated error-prone measuring signal sfₘ(t), then the differential signal Δs is equal to zero, which means that the weight signal M(t) at the output of the integrator 17 is stable. This weight signal M(t) corresponds to the weight actually measured with the weighing device 1 and is output as a weight value at the output 18.

The central analytical unit 9 also has a training device, which in the present can be formed of an optimization module 18, a data logger 19 and a branch module 20 (FIG. 3). The branch module 20 is located at the input 15 of the central analytical unit 9 and can branch off the measured measuring signal sₘ(t) and feed it with a data line 21 to the data logger 19, in which the measured measuring signals sₘ(t) are stored. The data logger 19 is connected to further data lines 22 and 23 to the output 12 of the function simulator 10 and to the input 11 of the function simulator 10 in order to read in the simulated error-prone measuring signal sfₘ(t) and the weight signal M(t).

If disturbance variables are detected, these disturbance variables are also read synchronously with the reference measuring signals and weight signals and stored in the data logger 19.

Furthermore, the optimization module has a data line 42 to the digital function simulator 10 in order to transmit parameters determined with an optimization method to the digital function simulator 10.

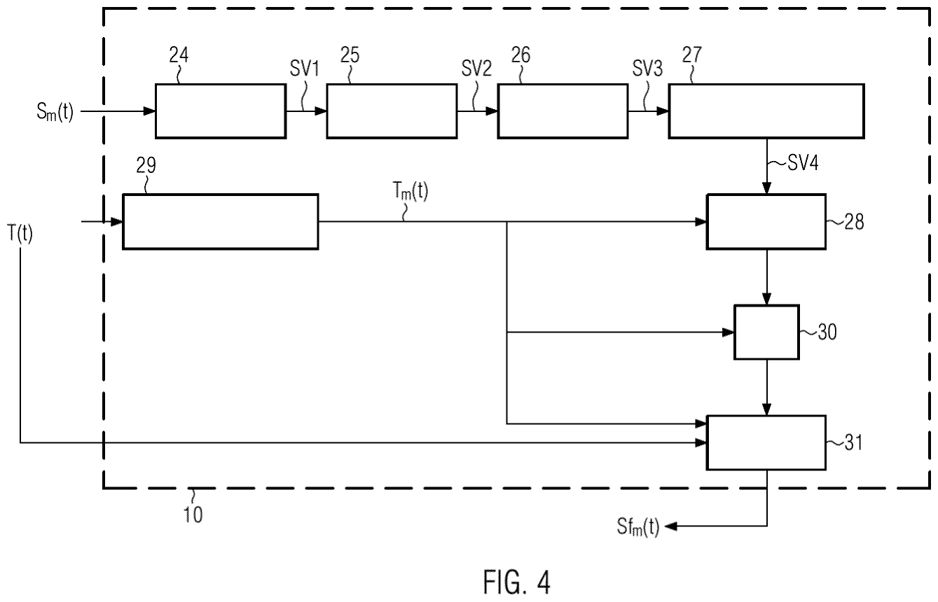

The digital function simulator 10 has a characteristic curve module 24, which is arranged directly at the input 11 of the digital function simulator (FIG. 4). The characteristic curve module converts the weight signal M(t) into a preliminary first measuring signal sv1(t) with a predetermined characteristic curve corresponding to the characteristic curve of the weighing device 1. The characteristic curve is approximated by means of the following cubic function:

Sv1=Pl*sₘ(t)+Pq*(sₘ(t))²+Pc*(sₘ(t))³

This function has a linear parameter Pl, a quadratic parameter Pq, and a cubic parameter Pc. With this function, the weight value is thus converted into a measuring signal sv1, which is a fictitious, essentially error-free measuring signal of the weighing device 1.

The characteristic curve is thus approximated by a non-linear function. As a result, nonlinearities of the real characteristic curve are corrected.

The characteristic curve module 24 is followed by an error simulation module 25 for correcting the creep of a measuring body. In the load cells 3, the strain gauges 5 are attached to a measuring body that deforms under load. The deformation of the measuring body is measured by means of the strain gauges 5. If the load on the measuring body persists for a longer period of time, the measuring body becomes increasingly deformed. This is called creep. Creep is simulated with a low-pass filter. In order to calculate the effect of creep on the preliminary measuring signal sv1, a time constant P_{tau-kriech-mess} is required for the creep of the measuring body. The time constant for the creep P_{tau-kriech-mess} is to be determined by means of an optimization method.

With the creep error simulation module 25, the first preliminary signal sv1 is converted into a second preliminary signal sv2, wherein the measuring signal is changed according to the creep effect on the weighing device 1. The second preliminary measuring signal sv2 has thus been modified accordingly as it takes place in the weighing device 1 by creep.

The second preliminary measuring signal sv2 is fed to an error simulation module 26 for correcting a hysteresis. In this embodiment, the hysteresis effect is simulated by means of a model. In the literature, different models for simulating hysteresis are known, such as: the dipole model (Similarity to Magnetic Dipoles; KÖNIG, Hans Günter. PROPERTIES OF METALLIC MEASURING BODIES FOR WIND TUNNEL MEASUREMENT TECHNOLOGY. Thesis; Technical University of Darmstadt, June 1992), the Preisach model (Sum of Elementary Hysteresis Operators; F. Preisach: On the magnetic aftereffect. In: Zeitschrift fOr Physik. Volume 94, 1935, pp. 277-302), the Dahl model (P. R. Dahl Solid friction damping of mechanical vibrations AIAA J., 14 (12) (1976), pp. 1675-1682), the Masing model (Parallel Connection of Elementary Ideal Elastic-plastic Elements; GUTZER, Ulrich; DYNAMIC IDENTIFICATION OF STATIC HYSTERESIS USING THE EXAMPLE OF A CONDUCTOR; Thesis; Technical University of Darmstadt, January 1998), the similarity model (purely mathematical model based on the assumption that internal hysteresis loops are similar to the enveloping one; KÖLSCH, H. VIBRATION DAMPING BY STATIC HYSTERESIS. Series 11: Vibration technology; Volume 190. Progress Reports VDI; VDI-Verlag, 1993), or the Lu-Gre model (Slip-Stick-Based Friction Model; Karl Johan Åström, C. Canudas de Wit Revisiting the LuGre Friction Model; Stick-slip motion and rate dependence IEEE Control Systems Magazine, 28 (6) (2008), pp. 101-114).

When calculating the hysteresis effect, e.g., the following parameters to be determined by means of the optimization method must be taken into account:
P_hyst—force from which a fictitious friction element slides;
P_sigma—spring constant, a spring that acts on the fictitious friction element; and/or
P_alpha, P_beta—parameters that define the deviation from a linear curve of the characteristic curve.

The composition of parameters may vary depending on the model.

The error simulation module 26 for hysteresis changes the preliminary second measuring signal sv2 to a preliminary third measuring signal sv3 according to the hysteresis effect occurring in the weighing device 1.

Downstream from the error simulation module 26 for hysteresis is an error simulation module 27 for the creep of the strain gauges 5. The creep of the strain gauges is simulated by a low-pass filter in combination with a correction term proportional to the derivative after time t. For the calculation, P_{tau kriechDMS} for the time constant of the strain gauge creep and a parameter P_{kriechEMS}, which describes a short-term overshoot of the measuring signal when the strain gauge creeps, are required as a parameter to be determined with the optimization method. With the error simulation module 27 for the creep of the strain gauges 5, a fourth preliminary measuring signal sv4 is generated.

The fourth preliminary measuring signal sv4 is fed to an error simulation module 28 for a zero point correction. The zero point is temperature-dependent. At the input 13 of the digital function simulator 10, the time-varying temperature signal T(t) is present. Experience has shown that the temperature value of the temperature sensors changes faster than the temperature value of the measuring body of the load cell 3. However, the temperature of the measuring body is relevant for the change in the zero point. Therefore, the temperature signal T(t) is first filtered with a low-pass filter 29, which results in a delayed temperature value Tm(t), which corresponds to the temperature of the measuring body.

The effect on the measuring signal due to the zero deviation is calculated using the following formula:

sv5=sv4+Ptk0*(Tm(t)−Tref)),
wherein sv5 is the fifth preliminary measuring signal, Tref is a reference temperature at which there is no deviation from the zero point, and Ptk0 is a parameter to be set by means of the optimization method, which describes the change in the zero point as a function of the deviation of the temperature from the reference temperature.

The measurement sensitivity of the strain gauges 5 is temperature-dependent, which is why the fifth preliminary measuring signal sv5 is corrected to a sixth preliminary measuring signal sv6 by means of an error simulation module 30 for the change in the sensitivity of the strain gauges. This correction is done using the following formula:

Sv6=sv5*(1+PtkC*(Tm(t)−Tref)),
wherein the parameter PtkC to be determined by means of the optimization method represents the temperature-dependent sensitivity of the strain gauges.

A temperature gradient leads to thermal stresses on the measuring body. The thermal stresses lead to deformations of the measuring body, which are detected by the strain gauges 5 and cause a systematic error of measurement. Therefore, the sixth preliminary measuring signal sv6 is fed to another error simulation module 31 to correct the influence due to the temperature gradient. In this error simulation module 31, in addition to the “delayed” temperature value of the measuring body Tm(t), the temperature value T(t) actually measured with the temperature sensor is also taken into account and the temperature difference between these two temperature values is calculated. This temperature reference value is multiplied by a correction parameter Pgradient and added to the sixth preliminary measuring signal sv6 according to the following formula, whereby the error-prone measuring signal sfₘ(t) is calculated:

sfₘ(t)=sv6+(T(t)−Tm(t))*Pgradient,
whereby the error-prone measuring signal output at the output of the digital function simulator 10 is generated. The determination of the gradient value by means of the low-pass filter 29 is possible for weighing devices in which the heat flow is always rectified. If there is a heat flow in different directions, then it is advisable to use two or more temperature sensors in order to be able to determine the direction(s) of the heat flow.

In the weighing device shown in FIG. 1, with which molten metal is weighed at a blast furnace, there is always a heat flow in one direction. In this weighing device, the function simulator with all error simulation modules 25-31 is used.

In order for the digital function simulator 10 to correctly reproduce the weighing device 1, it must be trained. For this purpose, a reference signal is applied to the weighing device. The reference signal can be generated, for example, by placing a calibration body with a predetermined weight. However, the calibration signal can also be generated by means of a mechanical force generating device, such as a plunger and a reference load cell, which is applied to the weighing device, wherein the reference load cell is a high-precision load cell for measuring the reference signal.

In the case of a weighing device such as that shown in FIG. 1, which is intended to weigh large quantities of hot melt, it is appropriate to use one or more reference pans, each with a predetermined weight, as reference weights.

The central component of the training device is the optimization module 18, which can receive the reference measuring signals by means of the branch module 20 and the data logger 19 and temporarily store them in the data logger 19 and at the same time records the weight signals M(t) generated by the evaluation loop 14.

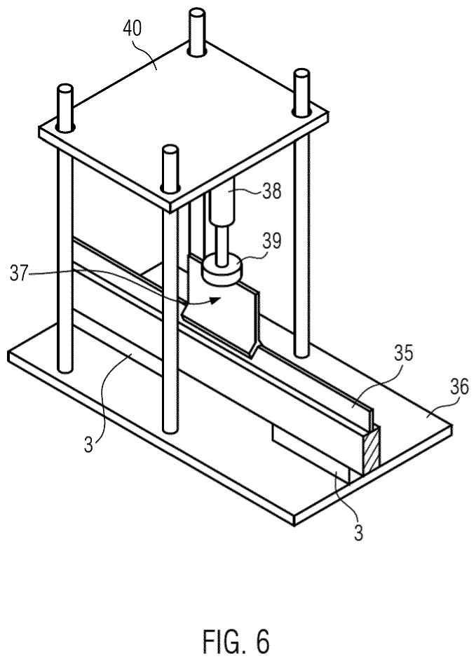

In a training method, reference measuring signals s_{m-ref}(t) are first generated by means of one or more reference weights or a reference device, as shown in FIG. 6, for example. The reference measuring signals, the reference weights and, if necessary, the disturbance variables are stored in the data logger 19.

Using an optimization method, the individual parameters P are varied on the digital function simulator 10 so that the reference weight(s) are applied to input 11 of the function simulator 10 and the error-prone measuring signal sfₘ(t) simulated thereon is aligned with the acquired stored reference measuring signals s_{m-ref}(t) as far as possible.

As a result, the deviation or error of the simulated error-prone measuring signals sfₘ(t) can be minimized during the training process.

With such an optimized digital function simulator 10, a weight signal M(t) can be generated from the weight measuring signal sₘ(t) with the evaluation loop 14, which is corrected with regard to the errors simulated by the individual error simulation modules. The error simulation modules could therefore also be referred to as correction modules.

There are different optimization methods with which the error can be minimized. In the present embodiment, a particle swarm optimization (PSO) in combination with the Levenberg-Marquardt algorithm was applied as an optimization method, which is a numerical optimization method for solving non-linear compensation problems using the method of least squares.

Furthermore, gradient-based methods can be used as optimization methods, but in principle non-gradient-based methods can also be used. Gradient-based methods include the gradient descent method, the constrained gradient descent method or the quasi-Newton method. They only require a small deflection of the control parameters of the weighing device around their operating state.

Gradient-based methods have the advantage that they provide a very precise model of the respective system for the environment of the operating state, which can be determined easily and quickly with a deflection of a control parameter.

Non-gradient-based methods are, for example, the Nelder-Mead simplex method or the method of differential evolution. An overview of different optimization methods is given, for example, in the textbook Optimization by Florian Jarre and Josef Stör (DOI10.1007/978-3-642-18785-8).

Regardless of whether the optimization method is a gradient-based method or a non-gradient-based method, it usually is an iterative optimization method that optimizes the parameters step by step.

If the reference signal is generated with a pressure cylinder and picked up with a reference load cell, then the training procedure can be executed fully automatically. If, however, different reference weights are applied manually, the training procedure must be carried out semi-automatically and each reference weight must be entered at a suitable point on the central analytical unit 9.

The digital function simulator 10 shown in FIG. 4 is specifically designed for a weighing device. In principle, it would be possible to use a general model instead of such a specific model, which is represented, for example, by a neural network. However, the use of such a specific model requires significantly fewer reference values in training, which makes training much easier and faster. In some cases, it may even be sufficient to apply only the zero load and another reference load during training in order to fully train the digital function simulator 10.

During training, all measured values, the corresponding disturbance variables and the reference loads are preferably recorded and stored synchronously in order to be available for the optimization process.

In the above embodiment, the training device 18, 19, 20 is integrated in the central analytical unit 9. In principle, it is also possible to first record all reference data during the training process and to carry out the optimization on a device independent of the central analytical unit, on which a copy of the evaluation loop 14 is kept.

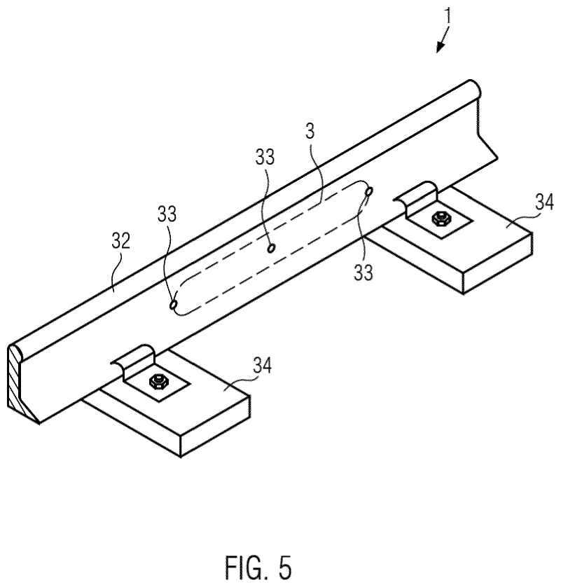

A second embodiment of a weighing device 1 is a rail scale which has several load cells 3 along two rails 32 of a train track. FIG. 5 schematically shows only a section of a single rail 32 with a schematic representation of the load cell 3. The load cell 3 has three strain gauges 33 glued to the track, with load cell 3 located in the area between two sleepers 34. Such a load cell 3 may also have more than three strain gauges 33. If the rail 32 is loaded in the area of the load cell 3, then the rail 32 bends and this deflection is detected by the load cell 3. The rail 32 thus serves as a measuring body. This weighing device 1 may comprise a plurality of load cells 3 along two rails 32 of a track, which are attached, for example, to the rails 32 at regular intervals over a distance of 20-50 m. As a result, the weight of a wagon on the track can be recorded when the wagon is moving slowly. Here, several groups of load cells 3, which are arranged close to each other, are each connected to a central analytical unit 9, so that the individual groups of load cells 3 are recorded and analyzed independently of each other.

For this rail scale, essentially the same function simulator of the above embodiment shown in FIG. 4 can be used. However, the thermal influences of this rail scale are not clearly aligned, so it is advisable to provide two or more temperature sensors so that temperature gradients in one or more directions can be clearly detected.

Another embodiment is a weighing device 1 for bogies of trains. FIG. 6 shows only a single section of a rail 35, which rests on two load cells 3. The load cells 3 are in turn arranged on a base plate 36. There is no further connection between the rail 35 and the base plate 36, so there is no force shunt to the load cells 3. The load cells 3 are rigidly connected to both the base plate 36 and the rail 35, i.e., they are either bolted or connected to each other with a press fit.

A reference device comprising a plunger 37, a hydraulic cylinder 38 and a reference load cell 39 is arranged on this weighing device 1. The reference load cell 39 is coupled to the plunger 37 and the hydraulic cylinder 38 by means of elastomeric bearings. The hydraulic cylinder 38 is attached at its upper end to a support plate 40, which is connected to the base plate 36 with support rods 41.

By actuating the hydraulic cylinder 38, a force can be exerted on the plunger 37, which is transmitted to the rail 35 and thus detected by the load cells 3. The reference load cell 39 accurately measures the force exerted by the hydraulic cylinder 38 and generates a reference signal.

With this reference device, a sequence of different reference signals can be automatically generated, acquired, and used to optimize a digital function simulator 10.

After training the parameters of the digital function simulator, the reference device is removed and the weighing device can be used to weigh the bogies.

Such weighing devices for bogies are usually arranged in halls in which defined temperature conditions exist. This weighing device is therefore subject to no or negligible temperature fluctuations.

It has been shown that this weighing device 1 can be simulated very well with a digital function simulator 10, which only has the characteristic curve module 24 and the error simulation module 26 for correcting the hysteresis effect. All other error simulation modules, which are present in the embodiment shown in FIG. 4, can be omitted.

With the characteristic curve module, which approximates the characteristic curve with a cubic function, is used on the one hand to convert the weight signal into a measuring signal and on the other hand to compensate non-linearity of the characteristic curve.

With the error simulation module 26 for a hysteresis effect, the hysteresis effects that occur with this weighing device 1 are very well compensated.

This example shows that not all error simulation modules of the digital function simulator 10 from FIG. 4 are always necessary to simulate a weighing device. Depending on the causes of error in a weighing device, the appropriate error simulation modules can be selected.

The individual error simulation modules 25-31 can be switched on individually.

With a reference device, as shown in FIG. 6, with which the training process can be carried out automatically, the digital function simulator can also be trained with a different combination of error simulation modules. This makes it possible to determine which error simulation modules are actually relevant for the respective weighing device in order to minimize the error. If, for example, it turns out that a certain error simulation module does not bring about any improvement in minimizing the error, then this means that the error corrected by this error simulation module does not occur on the corresponding weighing device.

The invention has been exemplified above by means of several examples, which use a function simulator that picks up a weight signal as an input signal and generates an error-prone simulated measuring signal as an output signal. By means of the evaluation loop shown in FIG. 3, the actual, corrected weight can be determined with this function simulator and the measuring signal generated by the weighing device 1.

In principle, it is also possible to provide a digital function simulator that records the measured measuring signal as input and outputs a corrected weight value as output. The individual modules of the digital function simulator according to FIG. 4 are then to be inverted accordingly. For individual modules, such inversion is simple, but for others it can be very complex, which is why the non-inverted digital function simulator explained above is easier to implement.

The invention can be briefly summarized as follows:

The invention relates to a weighing device and a weighing method, with a central digital measured value correction. The weighing device is simulated on a central analytical unit including a digital function simulator of the weighing device. The digital function simulator of the weighing device can be trained by means of a training device so that errors of measurement of the weighing device can be compensated.

In this way, it is possible to obtain reliable and precise weighing results with weighing devices of little complexity.

In the example explained above, the measuring signal collection station 7 is located near the load cells 3. The measuring signal collection station is connected to the central analytical unit 9 with a data line 8, which is much longer than the data lines between the load cells 3 and the measuring signal collection station 7. The data line 8 may have a length of at least 10 m, in particular 20 m and in particular 30 m.

However, the measuring signal collector station 7 may also be integrated into the central analytical unit 9 within the scope of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A weighing device with a central digital measured value correction, the weighing device comprising:
a central analytical unit having an analytical unit to determine a force measured with the weighing device on the basis of a weight measuring signal;
at least one load cell which is connected by a signal and/or data line to the central analytical unit for transmitting the weight measuring signal;
a digital function simulator arranged in the analytical unit and comprising one or more error simulation modules, each error simulation module representing a model of the weighing device simulating at least one specific error of measurement of the weighing device, and each error simulation module having one or more model parameters with which the weighing device is modelled; and
a training device with which the model parameters are determined during a training process in which reference measuring signals are generated via one or more reference loads,
wherein the digital function simulator has a characteristic curve module that converts the weight measuring signal into a weight signal or vice versa and the characteristic curve module has characteristic curve parameters which are determined by means of the training device during the training process.

2. The weighing device according to claim 1, wherein the characteristic curve module converts the weight signal into the weight measuring signal and the error simulation modules for simulating the weight signal are designed in such a way that they change the weight measuring signal by an error occurring at the weighing device.

3. The weighing device according to claim 1, wherein each of the several error simulation modules is adapted to be switched off.

4. The weighing device according to claim 1, wherein the weighing device has a plurality of load cells, and wherein the signals of the individual load cells are combined to form the weight measuring signal.

5. The weighing device according to claim 1, wherein at least one of the load cells has one or more strain gauges.

6. The weighing device according to claim 1, wherein the load cells are integrated into the weighing device with rigid connections.

7. The weighing device according to claim 1, wherein the weighing device has a temperature sensor arranged on or near at least one of the load cells for detecting the temperature.

8. The weighing device according to claim 1, wherein at least two or more error simulation modules are provided for correcting each of the following error causes:
linearity;
creep (force absorption, load cell);
hysteresis;
thermal deviations of the zero point;
deviations of the zero point with respect to a thermal gradient;
deviations in the sensitivity of the load cells due to temperature changes;
blows;
position of the load;
lateral forces; and/or
errors due to inclination.

9. The weighing device according to claim 8, wherein the characteristic curve module approximates the characteristic curve of the weighing device with a nonlinear function.

10. A weighing method with a central digital measured value correction, the method comprising:
recording, via at least one load cell, a weight measuring signal that is transmitted via a signal and/or data line to a central analytical unit;
determining by the central analytical unit with an analytical unit, the force measured with the weighing device on the basis of the weight measuring signal; and
converting, via the analytical unit, the weight measuring signal into a weight signal using a digital function simulator of the weighing device to simulate the weighing device with its error effects and thereby compensating the errors in the weight signal.

11. The weighing method according to claim 10, wherein the digital function simulator has been trained in advance with a training device during a training process in which reference measuring signals have been generated by one or more reference loads.

12. The weighing method according to claim 11, wherein the training process is based on an iterative optimization process.

13. The weighing method according to claim 10, wherein a characteristic curve module of the function simulator converts the weight measuring signal into the weight signal or vice versa for simulation and the characteristic curve module has characteristic curve parameters which have been predetermined by means of the training process.

14. The weighing method according to claim 10, wherein one or more error simulation modules of the digital function simulator of the weighing device simulate at least one specific error of measurement of the weighing device each, and each error simulation module uses one or more model parameters which have been predetermined by the training process.
